(19) United States
(12) Patent Application Publication
(10) Pub. No.: US 2024/0239501 A1
(43) Pub. Date: Jul. 18, 2024

(54) AIRCRAFT HAVING A BATTERY BLOCK

(71) Applicant: Wingcopter GmbH, Weiterstadt (DE)

(72) Inventor: Jonathan HESSELBARTH, Darmstadt (DE)

(73) Assignee: Wingcopter GmbH, Weiterstadt (DE)

(21) Appl. No.: 18/557,101

(22) PCT Filed: Apr. 26, 2022
(86) PCT No.: PCT/EP2022/061070

§ 371 Date: Jan. 25, 2024

(30) Foreign Application Priority Data
Apr. 26, 2021 (DE) 10 2021 110 636.2

(51) Int. Cl. B64D 27/357; B64D 27/40

(52) U.S. Cl. CPC B64D 27/357; B64D 27/402

(57) ABSTRACT

An aircraft has a battery block for supplying the aircraft with energy. The battery block is arrangeable within a battery compartment of the aircraft. The battery compartment is arranged within a volume formed by a fuselage of the aircraft and is accessible from the outside through a receiving opening in the fuselage. The battery block is introducible into the battery compartment through the receiving opening. When the aircraft is used as intended, the receiving opening is arranged on an upwardly facing top side of the fuselage. The battery block is insertable into the battery compartment by the battery block being moved along an introduction axis oriented substantially parallel to the direction of gravitational force. The battery block comprises a handle, which, when the battery block has been inserted properly into the battery compartment, is accessible from outside the aircraft.

### CROSS-REFERENCE TO RELATED APPLICATION

This application is a national stage application, filed under 35 U.S.C. § 371, of International Patent Application PCT/EP2022/061070, filed on Apr. 26, 2022, which claims the benefit of German Patent Application DE 10 2021 110 636.2, filed on Apr. 26, 2021.

### BACKGROUND

Vertical takeoff aircraft, for example so-called quadcopters, are known as aircraft for transporting general cargo. A quadcopter is an aircraft in which four rotors or propellers arranged in a plane and acting vertically downwards are used to generate lift. The propulsion of the quadcopter is generated by tilting the rotor plane. These aircraft can transport a certain payload over a certain distance, depending on their drive power. Depending on the drive power and payload, the range is limited by the available battery capacity.

Generally, the power supply of the aircraft is realized by means of exchangeable battery blocks, which, when in a depleted state, are replaced by new charged battery blocks, thus enabling a rapid continuation of flight operations without the need for a lengthy charging period required by permanently installed battery blocks. The battery blocks are usually inserted into a battery compartment on the side, which can be closed by a flap to protect the accumulator from falling out during flight or to protect it from environmental influences. After inserting the battery block into the battery compartment, an electrical connection lead attached to the battery block is connected to the aircraft to establish the electrical connection.

Sideways insertion of the battery block into the battery compartment can be awkward and time-consuming. In particular, the handling of the battery block during the sideways insertion of the battery block into the battery compartment requires a great deal of care and experience, as the battery block is usually very heavy. Since the aircraft is usually of lightweight construction, the center of gravity of the aircraft may be altered when the battery block is not fully inserted, such that the aircraft tilts to one side together with the battery block. Furthermore, the electrical connection of the battery block to the aircraft and the subsequent closing of the flap requires additional time. Likewise, the cumbersome handling of the battery block when removing it from the battery compartment or disconnecting the electrical connection between the battery block and the aircraft leads to additional time expenditure when replacing the battery block.

Other known aircraft provide for the installation of the battery blocks on an underside of the aircraft. Such an installation of the battery block may require time-consuming removal of attachments mounted on the underside of the aircraft, such as winches, transport containers or mounting devices. Furthermore, for good accessibility to the underside of the aircraft, the aircraft must be turned upside down, which, depending on the size and construction of the aircraft, requires a great deal of time and effort. Replacing a battery block mounted on the underside of the aircraft is therefore also very cumbersome and time-consuming.

### SUMMARY

The disclosure relates to an aircraft having a battery block for supplying the aircraft with energy. The battery block is arrangeable within a battery compartment of the aircraft. The battery compartment is arranged within a volume formed by a fuselage of the aircraft and is accessible from the outside through a receiving opening of the fuselage such that the battery block is introducible into the battery compartment through the receiving opening.

An object of the present design is to provide an aircraft with a battery block that can be removed from and inserted into the aircraft particularly quickly and easily.

This object is achieved in that when the aircraft is used as intended, the receiving opening is arranged on an upwardly facing upper side of the fuselage, such that the battery block is insertable into the battery compartment by the battery block being moved along an introduction axis oriented substantially parallel to the direction of gravitational force, wherein the battery block comprises a handle, which, when the battery block has been inserted properly into the battery compartment, is accessible from outside the aircraft.

For this purpose, the battery block can be inserted into the battery compartment particularly easily due to gravity by lowering the battery block. By inserting the battery block into the battery compartment from above, the aircraft can remain on the ground while the battery block is installed, eliminating the need to turn the aircraft upside down. This makes it particularly easy and quick to install the battery block in the battery compartment.

The battery compartment is arranged within the fuselage such that the overall centers of gravity of the aircraft are unchanged before and after the battery block is installed in the aircraft. This means that the aircraft can be secured against tipping over at any time. If the battery block is changed manually, it is not necessary to secure the aircraft against tipping over by holding or restraining the aircraft. This enables the battery block to be changed quickly, so that flight operations can be resumed particularly quickly.

The battery compartment is designed such that the battery block inserted from above through the receiving opening into the battery compartment can be secured within the battery compartment in a form-fitting manner. Advantageously, the battery compartment is pocket-shaped so that the battery block inserted into the pocket-shaped battery compartment remains in a lowermost position within the battery compartment due to gravity. Thus, the battery pack is securely received within the battery compartment when the aircraft is used as intended.

The handle allows the battery block to be inserted and pulled out of the battery compartment particularly conveniently and quickly. The handle can advantageously be designed as a handle-shaped grip, which has a gripping area in which the handle or the battery block can be gripped. In order to achieve a particularly low flow resistance during flight operation, it is provided that the handle is designed as a recess with an undercut made in the battery block cover, such that no grip device protruding from the fuselage of the aircraft influences the flow resistance. The handle in the form of a recess is advantageously designed so that fingers, hands or a gripping device can be inserted into it and the battery block can be gripped through the undercut. In particular with heavy battery blocks, a handle-shaped grip is preferable for carrying comfort of the battery block.

In an advantageous implementation, it is provided that the battery block is cuboid in shape. Advantageously, the battery block is also elongated so that a direction for inserting the battery block into the battery compartment is particularly easy to recognize. It is optionally provided that the battery block has a circular cross-section and is elongated. Thus, the direction for inserting the battery block into the battery compartment is known, wherein insertion is possible in all orientations of the battery block rotated about a longitudinal axis of the battery block.

Advantageously, an end face of the battery block facing the aircraft has a cross-sectional area corresponding to the receiving opening. This makes it particularly easy to insert the battery block through the receiving opening on the end face facing the aircraft. When the battery block is displaced along the introduction axis in the direction of the battery compartment, a guiding of the battery block is effected by an abutment of outer sides of the battery block against the receiving opening. This makes it particularly easy and quick to insert the battery block into the battery compartment.

In an advantageous embodiment, it is provided that the aircraft has at least two battery blocks arranged one behind the other in a longitudinal direction of the aircraft and in the direction of flight. By using a plurality of battery blocks to operate the aircraft, a high total battery capacity can be achieved, such that a particularly long flight operation is possible. It is provided that instead of a single large-capacity battery block, which typically has a large dimension and weight, two or more smaller-capacity battery blocks are used. As a result, the shift of the overall center of gravity generated by the weight of the battery blocks can be adjusted particularly well by an appropriate arrangement of the battery blocks within the fuselage. Due to the battery blocks being arranged one behind the other in the longitudinal direction of the aircraft and in the direction of flight, a shift of the center of gravity changing to one side of the aircraft can be avoided when the aircraft is operated with only one battery block. Thus, a particularly stable flight operation is possible due to the arrangement of the multiple battery blocks. It also avoids a lateral shift of the aircraft's overall center of gravity during the installation of the battery blocks. The fact that the two or more battery blocks are accessible from the top of the aircraft makes it particularly easy and quick to change the battery blocks.

So that a particularly low air resistance is generated by the aircraft in a horizontal flying position, an advantageous embodiment of the aircraft provides that the battery block has a battery block cover, wherein an outer contour of the battery block cover is adapted to a fuselage shape of a fuselage surface of the aircraft surrounding the receiving opening and, in an assembled state of the battery block, is flush with the fuselage surface of the fuselage. The battery block cover is arranged directly on a front side of the battery block. This means that the volume occupied by the battery block inside the battery compartment can be utilized particularly well and a particularly large battery block can be used. Advantageously, it is optionally provided that the battery block cover is arranged at a distance from the end face of the battery block. For this purpose, the battery block cover can, for example, be designed as a thin-walled component adapted to the shape of the fuselage, which is arranged on the battery block via spacer elements or fastening elements. The battery block cover can be made of a material that corresponds to the material of the fuselage. Typically, the fuselage of an aircraft is made of a fiber composite plastic, which has high stiffness and strength combined with low weight. Since the production of components made of fiber composite plastics is usually very time-consuming and costly, it is optionally provided that the battery block cover is made of a material different from the material of the fuselage of the aircraft. For example, the battery block cover can be made as a sheet of metallic material or of an injection-moldable plastic. To be able to adapt the shape of the battery block cover to the shape of the aircraft in a particularly advantageous manner, it is provided that the battery block cover is manufactured by means of additive manufacturing processes, for example by means of 3D printing.

In order to prevent liquid, such as rainwater, from entering the battery compartment, an advantageous embodiment provides that the battery block cover has a seal in the region of the outer contour, wherein, in the assembled state of the battery block, the seal abuts the fuselage in the region of the fuselage surface and covers the battery compartment in a liquid-tight manner. Thus, the battery block and the volume formed by the fuselage of the aircraft are protected against external environmental influences such as rain or dust.

In an advantageous implementation, it is provided that the aircraft has at least one electrical contact device having two electrical contact elements for producing an electrical connection between the battery block and the aircraft for supplying the aircraft with energy and/or for data transfer, wherein a first electrical contact element is arranged on an outer side of the battery block and a second electrical contact element is arranged on an inner side of the battery compartment such that the electrical connection is established with the battery block inserted into the battery compartment as intended. Advantageously, the first electrical contact element is arranged on a front side of the battery block facing when the battery block is inserted into the battery compartment, so that an electrical connection is only established when the battery block is fully inserted into the battery compartment. It is provided that the presence of the electrical connection between the battery pack and the aircraft is monitored by a control unit of the aircraft. In addition, the contact device can be used to transmit data on the status of the battery block, such as the current capacity, the current state of charge or the current operating conditions, such as the current power demand or the temperature. By monitoring the correct installation of all battery blocks, safe flight operations are possible.

In an advantageous embodiment of the aircraft, it is provided that the handle is hinged to the battery block cover on a side of the battery block cover facing away from the battery block. Thus, the handle can be folded up or out for pulling out or carrying the battery block, such that the handle can be gripped particularly well in the gripping area.

In an advantageous embodiment, in order to keep a flow resistance possibly generated by the handle during flight operation particularly low, it is provided that the battery block cover and/or the fuselage surface has a recess corresponding to the handle, such that the handle can be arranged within the recess in an unactuated state. In this case, the volume formed by the recess is completely filled by the handle when it is folded in. Advantageously, a surface of the handle facing outwards in a folded state of the handle is flush with the fuselage surface. Thus, turbulence or stalls at edges can be avoided during the flight operation of the aircraft. Thus, a low flow resistance of the aircraft is possible during flight operation, so that a particularly long service life of the aircraft is possible.

In order to arrange the battery block particularly securely within the battery compartment, in an advantageous implementation, it is provided that the battery block has a locking device with which the battery block can be fixed within the battery compartment in a form-fitting manner when the battery block is inserted into the battery compartment as intended. The locking device can, for example, be designed as a snap hook protruding laterally from the battery block, which engages in a recess arranged on an inner side of the battery compartment and corresponding to the snap hook when the battery block is inserted into the battery compartment. The locking device is designed in such a way that the snap hook is held within the recess by means of a spring force and can be pushed back against the direction of the spring force in order to release the form-fitting connection, such that the form-fitting connection can be released in order to be able to remove the battery block from the battery compartment again.

In an advantageous embodiment, it is provided that the locking device is operatively connected to the handle in such a way that the locking device can be actuated by a pivoting movement of the handle. Thus, locking or unlocking the battery block and pulling the battery block out of the battery compartment is possible by manually operating the locking device with only one hand. This allows a locking operation to be carried out particularly easily and quickly. It is provided that the handle is hinged to the battery block cover and has the handle-shaped grip on the outward-facing side of the handle and has the locking device on an opposite side of the gripping device. In this case, the locking device can be hook-shaped, which in an actuated state, i.e. in a folded state of the handle, engages in a corresponding recess arranged on the aircraft, such that a form-fitting locking of the battery block within the battery compartment takes place. Advantageously, the handle is hinged to the battery block cover such that a distance between a hinge point and the locking device is smaller than a distance between the hinge point and the gripping area. Thus, the handle can be operated particularly easily by a correspondingly large lever.

Further advantageous embodiments of the concept of the invention are explained with reference to exemplary embodiments shown in the drawings.

### BRIEF DESCRIPTION OF THE DRAWINGS

FIG. 1 shows a schematic representation of an aircraft having a battery block introduced into the battery compartment, and

FIG. 2 shows a schematic representation of the battery block cover.

### DETAILED DESCRIPTION

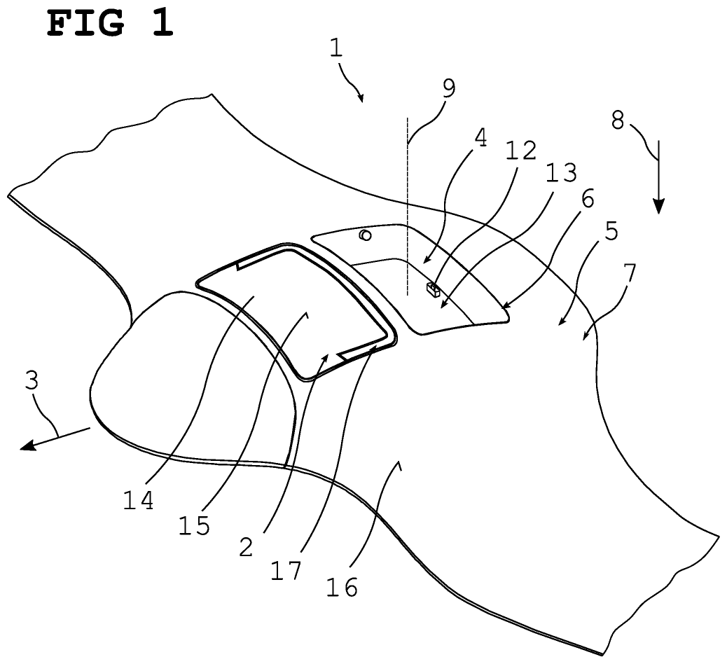

FIG. 1 shows a schematic representation of the aircraft 1 for receiving two battery blocks 2 for supplying the aircraft 1 with energy. In the aircraft 1 shown in FIG. 1, two battery blocks 2 are arrangeable one behind the other in the longitudinal direction of the aircraft 1 and in the direction of flight 3, wherein a first battery block 2 is inserted into a battery compartment 4 of the aircraft 1 in the front in the direction of flight 3 and a rear battery compartment 4 does not have a battery block 2 in the direction of flight 3. The battery compartment 4 is arranged within a volume formed by a fuselage 5 of the aircraft 1 and is accessible from the outside through a receiving opening 6 in the fuselage 5. The battery block 2 is introducible into the battery compartment 4 through the receiving opening 6. When the aircraft 1 is used as intended, the receiving opening 6 is arranged on an upwardly facing upper side 7 of the fuselage 5, such that the battery block 2 is insertable into the battery compartment 4 by the battery block 2 being moved along an introduction axis 9 oriented substantially parallel to the direction of gravitational force 8. The battery compartment 4 is pocket-shaped so that the battery block 2 inserted into the pocket-shaped battery compartment 4 remains in a lowermost position within the battery compartment 4 due to gravity. The aircraft 1 has an electrical contract device for establishing an electrical connection between the battery block 2 and the aircraft 1 for supplying the aircraft 1 with energy. A first electrical contact element 10 (not shown in FIG. 1) is arranged on an end face 11 of the battery block 2 facing the battery compartment 4 and a second electrical contact element 12 is arranged on an inner face 13 of the battery compartment 4, such that an electrical connection is only established once the battery block 2 is fully inserted into the battery compartment 4. In the embodiment of the battery block 2, the battery block 2 has a battery block cover 14. An outer contour 15 of the battery block cover 14 is adapted to a fuselage shape of a fuselage surface 16 of the aircraft 1 surrounding the receiving opening 6. In an assembled state of the battery block 2, it is flush with the fuselage surface 16. The battery block 2 has a handle 17, which, when the battery block 2 has been inserted properly into the battery compartment 4, is accessible from outside the aircraft 1. The handle 17 is receivable in an unactuated state through a recess made in the battery block cover 14, such that during flight operation flow resistance generated by the fuselage surface is particularly low.

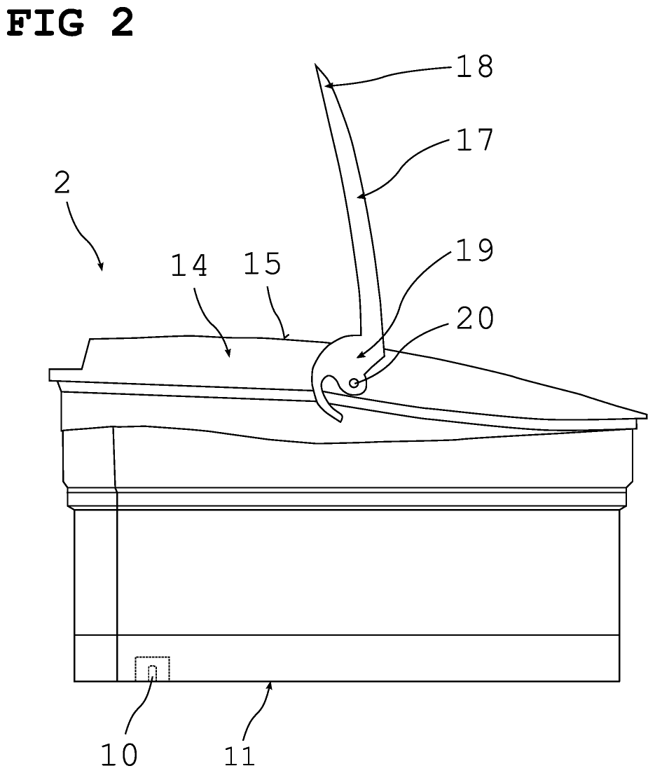

FIG. 2 shows a schematic representation of the battery block cover 14, which is arranged on one end face 11 of the cuboid battery block 2. The outer contour 15 of the battery block cover 14 is adapted to the fuselage shape of the fuselage surface 16 of the aircraft 1 surrounding the receiving opening 6 and, in an assembled state of the battery block 2, is flush with the fuselage surface 16 of the fuselage 5. The battery block cover 14 is designed as a thin-walled component adapted to the shape of the fuselage. The handle 17 of the battery block cover 14 is designed as a handle-shaped grip, which has a gripping area 18 in which the handle 17 or the battery block 2 can be gripped. The handle 17 is shown in an unfolded state in FIG. 2. The battery block 2 has a locking device 19 with which the battery block 2 can be fixed within the battery compartment 4 in a form-fitting manner when the battery block 2 is inserted into the battery compartment 4 as intended. The locking device 19 is operatively connected to the handle 17 in such a way that the locking device 19 can be actuated by a pivoting movement of the handle 17. Thus, locking or unlocking the battery block 2 and pulling the battery block 2 out of the battery compartment 4 is possible by manually operating the locking device 19 with only one hand. The handle 17 is hinged to the battery block cover 14 and has the handle-shaped grip with the gripping area 18 on the outward facing side of the handle 17. The locking device 19 is arranged on a side of the handle 17 opposite to the gripping area 18. In this case, the handle 17 is hinged to the battery block cover 14 such that a distance between a hinge point 20 and the locking device 19 is smaller than a distance between the hinge point 20 and the gripping area 18. The first electrical contact element 10 is arranged on the end face 11 of the battery block 2 facing the battery compartment 4, such that the electrical connection is established between the battery block 2 and the aircraft 1 is only produced once the battery block 2 is fully inserted into the battery component 4.

1.-10. (canceled)

11. An aircraft (1), comprising:
a battery block (2) for supplying the aircraft (1) with energy,
wherein the battery block (2) is arrangeable within a battery compartment (4) of the aircraft (1),
wherein the battery compartment (4) is arranged within a volume formed by a fuselage (5) of the aircraft (1) and is accessible from outside through a receiving opening (6) in the fuselage (5), such that the battery block (2) is introducible into the battery compartment (4) through the receiving opening (6),
wherein, when the aircraft (1) is used as intended, the receiving opening (6) is arranged on an upwardly facing top side (7) of the fuselage (5), such that the battery block (2) is insertable into the battery compartment (4) by the battery block (2) being moved along an introduction axis (9) oriented substantially parallel to a direction of gravitational force (8), and
wherein the battery block (2) comprises a handle (17), which, when the battery block (2) has been inserted into the battery compartment (4), is accessible from outside the aircraft (1).

12. The aircraft (1) according to claim 11,
wherein the battery block (2) is cuboid in shape.

13. The aircraft (1) according to claim 11,
wherein the aircraft (1) comprises at least two battery blocks (2), including the battery block (2) and at least one further battery block,
wherein the at least two battery blocks (2) are arranged one behind another in a longitudinal direction of the aircraft (1) and in the direction of flight (3).

14. The aircraft (1) according to claim 11,
wherein the battery block (2) comprises a battery block cover (14),
wherein an outer contour (15) of the battery block cover (14) is adapted to a fuselage shape of a fuselage surface (16) of the aircraft (1) surrounding the receiving opening (6) and is flush with the fuselage surface (16) of the fuselage (5) in an assembled state of the battery block (2).

15. The aircraft (1) according to claim 14,
wherein the battery block cover (14) comprises a seal in a region of the outer contour (15),
wherein, in the assembled state of the battery block (2), the seal abuts the fuselage (5) in the region of the fuselage surface (16) and covers the battery compartment (4) in a liquid-tight manner.

16. The aircraft (1) according to claim 11,
wherein the aircraft (1) comprises at least one electrical contact device having two electrical contact elements (10, 12) for producing an electrical connection between the battery block (2) and the aircraft (1) for supplying the aircraft (1) with energy and/or for data transfer,
wherein a first electrical contact element (10) is arranged on an outer side of the battery block (2) and a second electrical contact element (12) is arranged on an inner side (13) of the battery compartment (4) such that the electrical connection is established when the battery block (2) is inserted into the battery compartment (4).

17. The aircraft (1) according to claim 11,
wherein the handle (17) is hinged to the battery block cover (14) on a side of the battery block cover (14) facing away from the battery block (2).

18. The aircraft (1) according to claim 14,
wherein the battery block cover (14) and/or the fuselage surface (16) comprises a recess corresponding to the handle (17), such that the handle (17) can be arranged within the recess in an unactuated state.

19. The aircraft (1) according to claim 11,
wherein the battery block (2) comprises a locking device (19) with which the battery block (2) can be fixed within the battery compartment (4) in a form-fitting manner when the battery block (2) is inserted into the battery compartment (4).

20. The aircraft (1) according to claim 19,
wherein the locking device (19) is operatively connected to the handle (17) in such a way that the locking device (19) can be actuated by a pivoting movement of the handle (17).
